(19) United States
(12) Patent Application Publication
(10) Pub. No.: US 2016/0265226 A1
(43) Pub. Date: Sep. 15, 2016

(54) Square Ultrathin Wooden Floor with Linear Stitching Surface Board and Production Method Thereof

(71) Applicant: Zhaoyong Liang, Foshan (CN)

(72) Inventor: Zhaoyong Liang, Foshan (CN)

(21) Appl. No.: 14/864,915

(22) Filed: Sep. 25, 2015

(30) Foreign Application Priority Data
Mar. 10, 2015 (CN) 201510103990.6

(51) Int. Cl. E04C 2/30; E04F 15/02; E04F 15/022; B32B 38/00; B32B 21/14; B32B 5/02; B32B 3/06; B32B 37/18; E04C 2/28; B32B 21/10

(52) U.S. Cl. CPC E04C 2/30; E04C 2/28; E04F 15/02194; E04F 15/022; E04F 15/0215; B32B 21/10; B32B 21/14; B32B 5/022; B32B 3/06; B32B 37/18; B32B 38/0004; B32B 2419/04; B32B 2317/16

(57) ABSTRACT

A square ultrathin wooden floor with linear stitching surface board includes a surface board, a layer of nonwoven cloth and a bottom board. The surface board is linear stitched by at least two veneers, each of the at least two veneers has equal length and equal width. The surface board is bonding to one nonwoven cloth surface of the layer of nonwoven cloth by adhesive, other surface of the layer of nonwoven cloth is connected to the bottom board by pressure pasting. A thickness of the surface board is from 0.3 mm to 5 mm, a thickness of the bottom board is from 1.5 mm to 17 mm, a thickness of the square ultrathin wooden floor with linear stitching surface board is from 1.8 mm to 23 mm, a side length of the square ultrathin wooden floor with linear stitching surface board is greater than or equal to 300 mm.

### CROSS-REFERENCE TO RELATED APPLICATIONS

The present application claims the benefit of Chinese Patent Application No. 201510103990.6 filed on Mar. 10, 2015, the contents of which are hereby incorporated by reference.

### BACKGROUND

1. Technical Field

The present disclosure relates to wooden construction materials, and more particularly, to a kind of square ultrathin wooden floor with linear Stitching surface board and a production method thereof.

2. Description of Relate Art

An existing wooden floor is long-shaped and is made by bonding with surface board sliced a certain length and width and wood plank basic materials. Due to growth characteristic of wooden material and shortages of processing technology, the surface board can only be made into long-shaped. Conventional widths of floors are 90 mm, 120 mm and 148 mm. Meanwhile, production process of the surface board is in accordance with the width of more than a few conventional uniform widths. Surface boards of insufficient width are demoted. Surface boards of exceed the width are cutting. Many surface boards of width less than 90 mm are thrown away. Also due to production processes of slotting and planing, and the width after planing increasing 10 mm on a purpose width, the production processes will waste many materials. Utilization of wooded materials is very low because of the waste above resulting that wooden floor is high cost.

In addition, due to anisotropy of wooden materials, crack strength along a direction of trunk (which is used to be called correcting stripe) is greater than crack strength perpendicular to trunk transverse crack. Therefore, transverse anti-torsion cannot resist destruction to the surface board of thermal expansion and cold shrink. If a width of the surface board is too large, the surface will be easy to be cracked. Thus, use of the wooden floor is impacted.

In addition, square floor of on market such as art floor has many stitching cracks. Therefore, result of paving is not ideal even though lots of paving processes.

What is needed, therefore, is a square ultrathin wooden floor with linear Stitching surface board and production method thereof with can overcome the limitations described above.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a cross section of a square ultrathin wooden floor with linear Stitching surface board in accordance with an embodiment of the present disclosure.

FIG. 2 is a schematic diagram of a surface board of the square ultrathin wooden floor with linear stitching surface board stitching.

FIG. 3 is a schematic diagram of two square ultrathin wooden floors with linear stitching surface board stitching.

FIG. 4 is a flow chat of production method producing the square ultrathin wooden floor with linear Stitching surface board of FIG. 1 in accordance with an embodiment of the present disclosure.

### DETAILED DESCRIPTION OF THE EMBODIMENTS

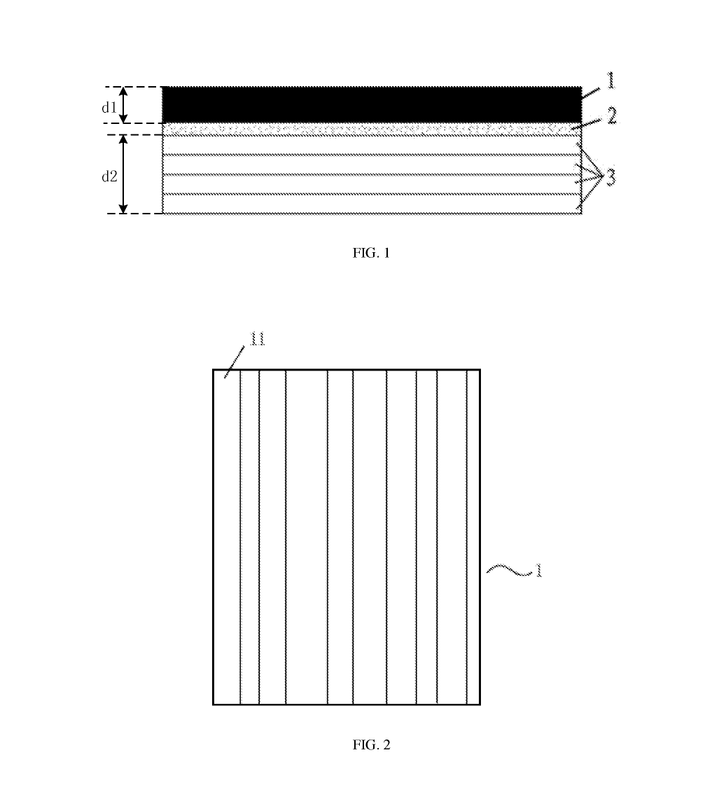

Referring to FIGS. 1-2, a square ultrathin wooden floor with linear stitching surface board 100 in accordance with an embodiment of the present disclosure is shown. The square ultrathin wooden floor with linear stitching surface board 100 includes a surface board 1, a layer of nonwoven cloth 3 and a bottom board 2. The surface board 1 is linear stitched by at least two veneers 11. Each of the at least two veneers 11 has equal length and equal width. The surface board 1 is bonding to one nonwoven cloth surface of the layer of nonwoven cloth 3 by adhesive. Other surface of the layer of nonwoven cloth 3 is connected to the bottom board 2 by pressure pasting. A thickness of the surface board 1 is from 0.3 mm to 5 mm, which is marked d1 in FIG. 1. A thickness of the bottom board 2 is from 1.5 mm to 17 mm, which is marked d2 in FIG. 1. The surface board 1, the layer of nonwoven cloth 3 and a bottom board 2 successively composite-form the square ultrathin wooden floor with linear stitching surface board 100 of this disclosure. A thickness of the square ultrathin wooden floor with linear stitching surface board 100 is from 1.8 mm to 23 mm, a side length of the square ultrathin wooden floor with linear stitching surface board 100 is greater than or equal to 300 mm.

The thickness of the surface board 1 is preferably from 0.5 mm to 3 mm. The veneers 11 are preferably solid wooden panels. More preferably, the veneers 11 are monolayer solid wooden panels. Each of the veneers 11 can has equal width or unequal width. The surface board 1 linear stitched by veneers 11 having unequal width can increase use of the wooden materials.

The square ultrathin wooden floor with linear stitching surface board 100 of the present disclosure can includes bottom board 2 which is formed by pasting several layers of solid wood panel. Every layer of solid wood panel has a thickness from 0.8 mm to 3 mm. The thickness of the bottom board 2 is preferably from 1.5 mm to 3 mm. A bottommost layer of solid wooden panel is linear stitched as the surface board to offset stress. The several layers of solid wood panel can be only one layer or more than one layer. It should be noted that, the bottom board 2 can be formed by other existing materials which can be used as substrate. The bottom board 2 can has various thicknesses. If the thickness of the surface board 1 is equal to the thickness of the bottom board 2, wooden floor combined by them can be ultrathin. For example, the thickness of the veneer 11 is 1.5 mm, the thickness of the bottom board 2 is 1.5 mm, a thickness of the wooden floor combined by them is 3 mm. A square wooden floor whose thickness is 3 mm has advantages of both square and ultrathin. It's convenience to pasts the square ultrathin wooden floor on the ground.

The thickness of the square ultrathin wooden floor with linear stitching surface board 100 is preferably from 2 mm to 6 mm. More preferably, the thickness of the square ultrathin wooden floor with linear stitching surface board 100 is from 3 mm to 5 mm. When the thickness of the square ultrathin wooden floor with linear stitching surface board 100 is 3 mm or 5 mm, the thickness of the square ultrathin wooden floor with linear stitching surface board 100 is ⅙ of the ordinary wooden floor, and is ⅚ materials supplies for less. Due to the linear stitching surface board 1, the wooden materials utilization rate is increasing.

It should be noted that, the side length of the square ultrathin wooden floor with linear stitching surface board 100 can be 300 mm, 400 mm, 450 mm, 500 mm, 600 mm, 8000 mm or 1000 mm. Also, the thickness of the surface board 1 can be 1 mm, 1.5 mm, 2 mm, 2.5 mm, 3 mm, 3.5 mm, 4 mm, 4.5 mm, 5 mm, 6 mm, 7.5 mm, 8 mm, 9 mm, 10 mm, 10.5 mm, 12 mm, 13.5 mm, 15 mm or 17 mm. Also, the thickness of the square ultrathin wooden floor with linear stitching surface board 100 can be 2.5 mm, 3 mm, 4 mm, 4.5 mm, 5 mm, 5.5 mm, 6 mm, 8 mm, 10 mm, 15 mm, 20 mm, 23 mm or more.

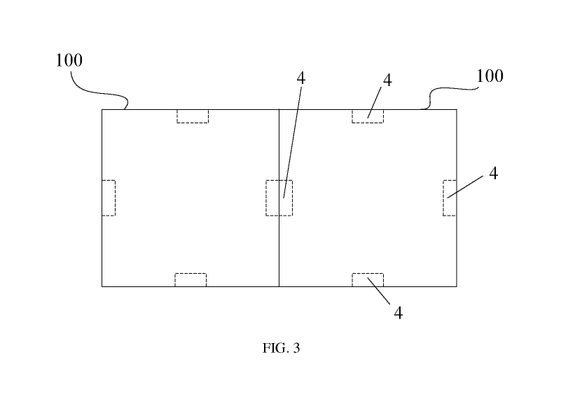

Referring to FIG. 3, a connection manner of the square ultrathin wooden floor with linear stitching surface board 100 in accordance with an embodiment of the present disclosure is shown. the square ultrathin wooden floor with linear stitching surface board 100 includes grooves 4 at four side surfaces. When combining, two grooves 4 of adjacent surface of the square ultrathin wooden floor with linear stitching surface board 100 are inserted with a wooden strip, so two adjacent square ultrathin wooden floors with linear stitching surface board 100 are combined. It is known that, two square ultrathin wooden floor with linear stitching surface board 100 can be combined by other combining manners. For example, two square ultrathin wooden floor with linear stitching surface board 100 can be combined by other manners without grooves 4, or can be combined by inserting other strip such as ceramic strips.

A common saw cut surface board of common wooden floor is long-shaped due to the shape of wooden materials is cylindrical-shaped. Because of the surface board is pasting on the surface of the wooden floor, a width of the wooden floor is limited. In addition, production process of the surface board is in accordance with the width. Surface boards of insufficient width are demoted. Surface boards of exceed the width are cutting. Many surface boards of width less than minimum standard (90 mm) can be used to product wooden floors. So the production processes will waste many materials. Utilization of wooded materials is very low because of the waste above resulting that wooden floor is high cost.

Different to existing wooden floor, the surface board 1 of this disclosure is formed by pasting veneers 11 having equal length and equal thickness by adhesive. The veneers 11 are solid wooden panels. Due to the thickness of the surface board 1 is so thin and only form 0.3 mm to 5 mm, it will be pulled out in the transverse direction of the wood grain or appears longitudinal direction cracks if used as sheet with large size. To overcome transverse tensile strength short comings of the surface board 1, the square ultrathin wooden floor with linear stitching surface board 100 includes a layer of nonwoven cloth 3 between the surface board 1 and the bottom board 2. Due to the layer of nonwoven cloth 3 has anti-torsion strength advantage, transverse tensile strength in all additions of the surface board 1 has been increased. Particularly, transverse tensile strength in transverse direction of the surface board 1 has been increased obviously. Thus, the surface board 1 is less prone to cracking when using, and shortages of thermal expansion and cold shrink of wooden floors. Even if sizes of the wooden floor are increased, it also shows excellent weather resistance. Also due to the thin thickness of the surface board 1, the surface boards 1 are difficulty stitched. If put the surface boards 1 on a continuous layer of nonwoven cloth 3, the difficulty of stitching the surface boards 1 is solved, and can be stitched strongly. It is found by testing that, the square ultrathin wooden floor with linear stitching surface board 100 formed by surface board 1 and the layer of nonwoven cloth, whose thickness is 4 mm, has a same anti-torsion strength of the existing wooden floor whose thickness is 8 mm. But wooden materials, adhesive and workload of the 4 mm square ultrathin wooden floor with linear stitching surface board 100 are only half of the 8 mm existing wooden floor. And, cost of production is also decreased.

For detecting tolerability of the square ultrathin wooden floor with linear stitching surface board 100 of this disclosure, inventors of this disclosure have experimented the square ultrathin wooden floor with linear stitching surface board 100 and the existing wooden floor. Testing processes are shown as follows:

1. Experiment Sample

Example: the square ultrathin wooden floor with linear stitching surface board 100 of this embodiment.

Reference: existing wooden floor with veneer as surface board.

2. Experiment Method

Step 1: putting the experiment samples into temperature and humidity constantly chamber, closing doors of the chamber, cyclically experimenting the experiment samples from −20° C. (time: 2 h) to 50° C. (time: 3 h, humidity: 65%) as the temperature and humidity constantly chamber setting. Cyclically experimenting the experiment samples for 6 times, 30 hours.

Step 2: taking out the experiment samples of the temperature and humidity constantly chamber after experimenting, and putting the experiment samples into an environment and standing for 20 hours. The environment has temperature of 20±2° C., relative humidity of 60%˜70%. Then, observing surface of the experiment sample by using 4× magnifying lens.

3. Experiment Result

| Experiment sample | Example | Reference |
|---|---|---|
| Appearance | No crack | Appears 3 cracks |

It is found through the above thermal cycling destructive experiment that, the square ultrathin wooden floor with linear stitching surface board 100 of this embodiment will not reduce anti-destruction capability, but also promote due to the layer of nonwoven cloth 3. Tolerability of the square ultrathin wooden floor with linear stitching surface board 100 has been promoted.

Also referring to FIG. 2, the square ultrathin wooden floor with linear stitching surface board 100 of this embodiment is not need to select veneers 11 after cut from width edges. That is to said, even the width of the veneers 11 after cut is equal or not, length and thickness of the veneers 11 can be stitched. Thus, it can solve problems of wasting veneers 11 whose width is less than 90 mm, and improve the wooden materials utilization rate. Besides, existing wooden floor should cut sides length from 10 mm to 20 mm of the wooden materials. Therefore, if the size of wood floor is smaller, the side length and waste wooden materials will be larger. Utilization of wooded materials is also lower.

For example, use one wood plank basic materials whose length multiplied by width is 1240 mm×2480 mm (area is 3.0752 m²) to produce wooden floors. Wooden materials utilization rate of using to produce existing wooden floor and using to produce the square ultrathin wooden floor with linear stitching surface board 100 of this embodiment can be compared. If the wood plank basic materials use to produce existing wooden floor (1200 mm×120 mm), the wood plank basic materials can be cut into 17 pieces. Length and width of every piece reserves 20 mm for the production of grooves. When these 17 pieces of existing wooden floor combining, it can cover an area of 1200 mm×120 mm×17=2.448 m², and wooden materials utilization rate is 2.448 m2÷3.0752 m2=79.6%. If the wood plank basic materials use to produce the square ultrathin wooden floor with linear stitching surface board 100 of this embodiment (600 mm×600 mm), the wood plank basic materials can be cut into 8 pieces. Length and width of every piece does not need to reserves for the production of grooves. When these 8 pieces of the square ultrathin wooden floor with linear stitching surface board 100 combining, it can cover an area of 1200 mm×120 mm×17=2.448 m², and wooden materials utilization rate is 2.88 m2÷3.0752 m2=93.6%.

It can be calculated that, a wood plank basic materials whose length multiplied by width is 1240 mm×2480 mm using to produce square ultrathin wooden floor with linear stitching surface board 100 can improve wooden materials utilization rate of 14% respecting to use to produce long-shaped existing wooden floor. By decreasing pieces number of wooded floor and side surfaces, wooden materials can be saved by decreasing side surface grooves. And, the surface board 1 of this disclosure is firstly stitched and secondly cut, the veneers 11 are no need to select width edges. Veneers 11 of smaller size can also be used. Then, the wooden materials utilization rate is improved from 15% to 25%.

It is known that, the square ultrathin wooden floor with linear stitching surface board 100 cutting by different size, such as 600 mm×600 mm described above can maximize the wooden materials utilization rate by using wood plank basic materials whose length multiplied by width is 1200 mm×2400 mm.

When the square ultrathin wooden floor with linear stitching surface board 100 is combining, two grooves 4 of adjacent surface of the square ultrathin wooden floor with linear stitching surface board 100 are inserted with a wooden strip, so two adjacent square ultrathin wooden floors with linear stitching surface board 100 are combined.

By improving the wooden materials utilization rate, cost of raw material is also reduced. Also, producing cost and human cost of producing big size wooden floor is reduced.

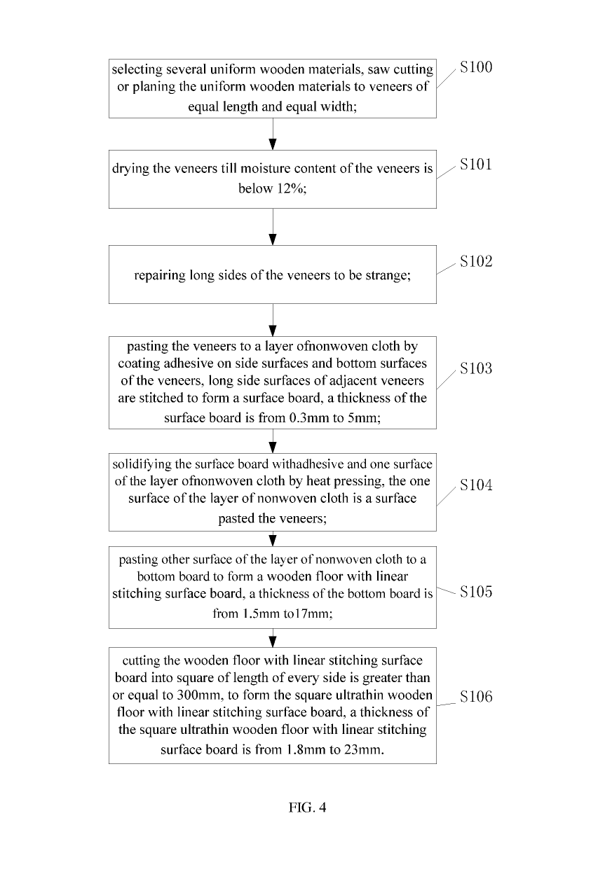

Referring to FIG. 4, a production method of the square ultrathin wooden floor with linear stitching surface board 100 in accordance with an embodiment of the present disclosure is shown. The production method includes following steps:

S100: selecting several uniform wooden materials, saw cutting or planing the uniform wooden materials to veneers of equal length and equal width.

The uniform wooden materials are wide variety of sources such as fir, pine, poplar, ash, paulownia, birch, basswood etc. The saw cut or planed veneers are no need to select width edges. Veneers having equal length and equal thickness can be used to produce the surface board 1.

S101: drying the veneers till moisture content of the veneers is below 12%;

It is known that, the veneers will be crack in following heat process if the moisture content is too low. The veneers will be deformed after following press process if the moisture content is too high. Therefore, preferable scheme moisture content of the veneers is below 12%.

It is known that, the moisture content of the veneers can be 6%, 7%, 8%, 9%, 10%, 11% or 12% and etc.

S102: repairing long sides of the veneers to be strange.

A key process about appearance of the surface board 1 is smooth or not, seamless or not is repairing strange. The long side can is repaired strange or not can directly impact stitching crack of two adjacent veneers is close or not. Right angle of edge of each veneers is less than or equal to 0.2 mm/m of the production method of this disclosure.

S103: pasting the veneers to a layer of nonwoven cloth by coating adhesive on side surfaces and bottom surfaces of the veneers, long side surfaces of adjacent veneers are stitched to form a surface board, a thickness of the surface board is from 0.3 mm to 5 mm.

It is known that, larger width ones of the veneers after repairing strange are firstly stitched, then smaller width ones of the veneers after repairing strange are secondly stitched according to requirement. During stitching the veneers, on one side, side surfaces the veneers are coated by adhesive to combined two adjacent veneers, on the other side, bottom surfaces of the veneers are also coated by adhesive to paste the veneers to the layer of nonwoven cloth. Combination open joint of the production method is 0.10 mm+0.05 mm. So the open joint cannot be seen on the surface board 1, and appearance quality of the surface board 1 can be guaranteed.

The thickness of the surface board 1 is preferably from 0.5 mm to 3 mm. The veneers 11 are preferably solid wooden panels. More preferably, the veneers 11 are monolayer solid wooden panels. Each of the veneers 11 can has equal width or unequal width. The surface board 1 linear stitched by veneers 11 having unequal width can increase use of the wooden materials.

The thickness of the surface board 1 can be 1 mm, 1.5 mm, 2 mm, 2.5 mm, 3 mm, 3.5 mm, 4 mm, 4.5 mm, 5 mm or etc.

S104: solidifying the surface board with adhesive and one surface of the layer of nonwoven cloth by heat pressing, the one surface of the layer of nonwoven cloth is a surface pasted the veneers.

Putting the surface board and the layer of nonwoven cloth with adhesive into heat pressing apparatus. Temperature of heat pressing at S104 is from 30° C. to 170° C., heat preservation time of heat pressing is form 20 s to 150 s. After the heat preservation time, put the surface board and the layer of nonwoven cloth with adhesive into a controlling room whose relative humidity is 75% to be cooled and solidified naturally and to control the compression ratio from 15% to 20%.

Preferably, the temperature of heat pressing at S104 is from 50° C. to 150° C., the heat preservation time of heat pressing is form 50 s to 120 s, the compression ratio is from 6% to 18%. It is known that, the temperature of heat pressing at S104 can be 50° C., 60° C., 70° C., 80° C., 90° C., 100° C., 110° C., 120° C., 130° C., 140° C., 150° C. or etc. The heat preservation time of heat pressing can b 50 s, 70 s, 90 s, 100 s, 120 s or etc. The compression ratio can be 16%, 17%, 18% or etc.

S105: pasting other surface of the layer of nonwoven cloth 3 to a bottom board to form a wooden floor with linear stitching surface board, a thickness of the bottom board is from 1.5 mm to 17 mm.

The bottom board 2 of the square ultrathin wooden floor with linear stitching surface board 100 of this disclosure can be formed by several layers of solid wood panel. Every layer of solid panel has a thickness from 0.8 mm to 3 mm, a bottommost layer of solid wooden panel is linear stitched as the surface board to offset stress. The thickness of the bottom board 2 is preferably from 1.5 mm to 3 mm. The several layers of solid wood panel can be only one layer or more than one layer.

The other surface of the layer of nonwoven cloth 3 is coated with adhesive. And the other surface of the layer of nonwoven cloth 3 is connected to the bottom board by putting into heat pressing apparatus. Temperature of heat pressing of the heat pressing apparatus is from 100° C., to 200° C., heat preservation time of heat pressing is form 2 min to 5 min. Then the bottom board 2 and the layer of nonwoven cloth 3 is putting into a controlling room whose relative humidity is 75% to be cooled and solidified naturally. Finally, a large floor substrate is formed.

Preferably, the temperature of heat pressing is from 120° C. to 180° C., the heat preservation time of heat pressing is form 3 min to 4 min. It is known that, the temperature of heat pressing can be 120° C., 130° C., 140° C., 150° C., 160° C., 170° C., 180° C. or etc. The heat preservation time of heat pressing can be 3 min, 3.5 min, 4 min or etc.

The thickness of the bottom board 2 can be 1.5 mm, 2 mm, 3 mm, 4 mm, 4.5 mm, 5 mm, 6 mm, 7.5 mm, 8 mm, 9 mm, 10 mm, 10.5 mm, 12 mm, 13.5 mm, 15 mm, 17 mm or etc.

S106: cutting the wooden floor with linear stitching surface board into square of length of every side is greater than or equal to 300 mm, to form the square ultrathin wooden floor with linear stitching surface board, a thickness of the square ultrathin wooden floor with linear stitching surface board is from 1.8 mm to 23 mm.

The thickness of the square ultrathin wooden floor with linear stitching surface board 100 is preferably from 2 mm to 6 mm. More preferably, the thickness of the square ultrathin wooden floor with linear stitching surface board 100 is from 3 mm to 5 mm. When the thickness of the square ultrathin wooden floor with linear stitching surface board 100 is 3 mm or 5 mm, the thickness of the square ultrathin wooden floor with linear stitching surface board 100 is ⅙ of the ordinary wooden floor, and is ⅚ materials supplies for less. Due to the linear stitching surface board 1, the wooden materials utilization rate is increasing.

The square ultrathin wooden floor with linear stitching surface board preferably includes grooves at four side surfaces. Specifically in S105, the floor substrate is cut in accordance with size requirement of wooden floor, cut grooves at the four side surfaces. Then the floor substrate is buffed and surface printed to get the square ultrathin wooden floor with linear stitching surface board 100 of this disclosure.

It is known that, the side length of the square ultrathin wooden floor with linear stitching surface board 100 can be 300 mm, 400 mm, 450 mm, 500 mm, 600 mm, 8000 mm, 1000 mm or etc. The thickness of the square ultrathin wooden floor with linear stitching surface board 100 can be 2.5 mm, 3 mm, 4 mm, 4.5 mm, 5 mm, 5.5 mm, 6 mm, 8 mm, 10 mm, 15 mm, 20 mm, 23 mm or etc.

It is believed that the present disclosure and its advantages will be understood from the forgoing description, and it will be apparent that various changes may be made thereto without departing from the spirit and scope of the present disclosure or sacrificing all of its material advantages, the examples hereinbefore described merely being preferred or exemplary embodiments.

What is claimed is:

1. A square ultrathin wooden floor with linear stitching surface board, comprising a surface board, a layer of nonwoven cloth and a bottom board, the surface board is linear stitched by at least two veneers, each of the at least two veneers has equal length and equal width, the surface board is bonding to one nonwoven cloth surface of the layer of nonwoven cloth by adhesive, other surface of the layer of nonwoven cloth is connected to the bottom board by pressure pasting, a thickness of the surface board is from 0.3 mm to 5 mm, a thickness of the bottom board is from 1.5 mm to 17 mm, a thickness of the square ultrathin wooden floor with linear stitching surface board is from 1.8 mm to 23 mm, a side length of the square ultrathin wooden floor with linear stitching surface board is greater than or equal to 300 mm.

2. The square ultrathin wooden floor with linear stitching surface board of claim 1, wherein the bottom board comprises several layers of solid wood panel, every layer of solid panel has a thickness from 0.8 mm to 3 mm, a bottommost layer of solid wooden panel is linear stitched as the surface board to offset stress.

3. The square ultrathin wooden floor with linear stitching surface board of claim 1, wherein the thickness of the surface board is from 0.5 mm to 3 mm, the thickness of the bottom board is from 1.5 mm to 3 mm, the thickness of the square ultrathin wooden floor with linear stitching surface board is from 2 mm to 6 mm, the at least two veneers are solid wooden panels.

4. The square ultrathin wooden floor with linear stitching surface board of claim 1, wherein the square ultrathin wooden floor with linear stitching surface board comprises grooves at four side surfaces.

5. A production method of the square ultrathin wooden floor with linear stitching surface board of claim 1, comprising steps:
S100: selecting several uniform wooden materials, saw cutting or planing the uniform wooden materials to veneers of equal length and equal width;
S101: drying the veneers till moisture content of the veneers is below 12%;
S102: repairing long sides of the veneers to be strange;
S103: pasting the veneers to a layer of nonwoven cloth by coating adhesive on side surfaces and bottom surfaces of the veneers, long side surfaces of adjacent veneers are stitched to form a surface board, a thickness of the surface board is from 0.3 mm to 5 mm;
S104: solidifying the surface board with adhesive and one surface of the layer of nonwoven cloth by heat pressing, the one surface of the layer of nonwoven cloth is a surface pasted the veneers;
S105: pasting other surface of the layer of nonwoven cloth to a bottom board to form a wooden floor with linear stitching surface board, a thickness of the bottom board is from 1.5 mm to 17 mm; and
S106: cutting the wooden floor with linear stitching surface board into square of length of every side is greater than or equal to 300 mm, to form the square ultrathin wooden floor with linear stitching surface board, a thickness of the square ultrathin wooden floor with linear stitching surface board is from 1.8 mm to 23 mm.

6. The production method of claim 5, wherein temperature of heat pressing at S104 is from 30° C. to 170° C., heat preservation time of heat pressing is form 20 s to 150 s.

7. The production method of claim 5, wherein the bottom board is formed by pasting several layers of solid wood panel, temperature of heat pressing at S105 is from 100° C., to 200° C., heat preservation time of heat pressing is form 2 min to 5 min.

8. The production method of claim 5, wherein the square ultrathin wooden floor with linear stitching surface board comprises grooves at four side surfaces at S106.

9. The production method of claim 5, wherein the right angle of edge of each veneers is less than or equal to 0.2 mm/m while repairing long sides of the veneers to be strange at S102.

10. The production method of claim 5, wherein the thickness of the surface board is from 0.5 mm to 3 mm, the thickness of the bottom board is from 1.5 mm to 3 mm, the thickness of the square ultrathin wooden floor with linear stitching surface board is from 2 mm to 6 mm, the veneers are solid wood panels.
